(19) United States
(12) Patent Application Publication
(10) Pub. No.: US 2025/0239830 A1
(43) Pub. Date: Jul. 24, 2025

(54) Erbium Doped Fiber Amplifier with Multiple Pump Lasers

(71) Applicant: II-VI Delaware, Inc., Wilmington, DE (US)

(72) Inventors: Ian Peter McClean, Brixham (GB); Nadhum Kadhum Zayer, Devon (GB); Paul Moore, Devon (GB)

(21) Appl. No.: 18/418,651

(22) Filed: Jan. 22, 2024

(51) Int. Cl. H01S 3/094; H01S 3/067; H01S 3/16

(52) U.S. Cl. CPC H01S 3/094096; H01S 3/06754; H01S 3/094003; H01S 3/1608

(57) ABSTRACT

A method of amplification in an optical fiber includes injecting into the optical fiber, by one or more pump lasers, between an input and an output end of the optical fiber, a first set of one or more wavelengths of pump laser light; and injecting into the optical fiber, by the one or more pump lasers, between the input and the output end of the optical fiber, a second set of one or more wavelengths of pump laser light. The wavelengths of the first and second sets of pump laser light injected into the optical fiber are different from each other and create an inversion in the optical fiber, and the wavelengths of the first and second sets of pump laser light injected into the optical fiber are different from the one or more communication wavelengths of laser light.

### BACKGROUND

### 1) Field

The present disclosure relates to a system and method for providing or creating inversion in an erbium doped fiber amplifier (EDFA).

### 2) Background

Erbium doped fiber amplifiers (EDFAs) are optically pumped amplifiers whereby a higher energy pump laser is used to create inversion within the energy bands that results in stimulated signal amplification. Common pump lasers operate at wavelengths of about 980 nm and about 1480 nm.

EDFAs are used in optical transmission systems to amplify a single signal channel or to simultaneously amplify multiple signal channels. It is important that all signal channels see the same gain through any EDFA to ensure the signal channels arrive at the receiver or receivers within the allowed input power range.

Within EDFAs there are several causes that result in non-equal amplification of all signal channels. One cause is related to the optical pump laser used to provide inversion for the gain process in the C-band or L-band. Specifically, 980 nm laser pumping is more commonly used in EDFAs than 1480 nm due to better noise performance, lower power dissipation and more compact modules. 980 nm pump lasers, however, can be a cause of gain variation across all signal channels through a process known as pump induced gain inhomogeneity (PIGI).

To this end, a 980 nm pump laser chip is a fabry-perot structure that will shift a central wavelength with changing operating temperature and drive current. As the center wavelength shifts, this creates an uneven change in the gain across all of the signal channels passing through the EDFA. This results in some signal channels gain changing significantly and others changing slightly. For example, short wavelength channels gain changes may be much larger than longer wavelength channels gain changes as the center wavelength of the pump laser chip shifts.

Fabry-perot 980 nm pump laser chips are therefore designed with a locking reflector, commonly a fiber Bragg grating (FBG), that ensures the laser wavelength is fixed over its operating conditions which minimises gain variation in the EDFA.

Pump lasers can be injected into a EDFA either co-propagating in the same direction as the propagation direction of the signal channels or counter-propagating in a direction opposite the propagation direction of the signal channels. Co-propagating provides lower noise performance. Counter-propagating provides higher output power.

Injecting both co-propagating and counter-propagating may lower noise and increase output power in the EDFA. However, injecting into the same EDF coil can result in light from one direction pump laser, not fully absorbed in the EDF, being coupled into the opposite pump laser. This can create instability in the opposing pump laser which in turn creates unwanted unstable gain in the EDFA. This is particularly an issue with lasers that are frequency locked, nominally to the same wavelength, due to the closeness of the locking wavelength.

Therefore a solution to minimise PIGI and prevent gain instability in a co- and counter-propagating 980 nm pumped EDFA is desired.

### SUMMARY

Disclosed is a method of amplification in an optical fiber having an input end for receiving, from one or more laser transmitters, one or more communication wavelengths of laser light and an output end for outputting, to one or more laser receivers, the one or more communication wavelengths of laser light. The method comprises: (a) injecting into the optical fiber, by one or more pump lasers, between the input and the output end of the optical fiber, a first set of one or more wavelengths of pump laser light; and (b) injecting into the optical fiber, by the one or more pump lasers, between the input and the output end of the optical fiber, a second set of one or more wavelengths of pump laser light, wherein: the wavelengths of the first and second sets of pump laser light injected into the optical fiber are different from each other in a range between 968 nm and 982 nm or between 1470 nm and 1490 nm and create an inversion in the optical fiber; and the wavelengths of the first and second sets of pump laser light injected into the optical fiber are different from the one or more communication wavelengths of laser light.

The first set of the one or more wavelengths of pump laser light and second set of the one or more wavelengths of pump laser light may be injected into the optical fiber in the same direction toward the output end of the optical fiber or toward the input end of the optical fiber.

The first set of the one or more wavelengths of pump laser light and second set of the one or more wavelengths of pump laser light may be injected into the optical fiber in different directions.

Injecting the first and second sets of one or more wavelengths of the pump laser light into the optical fiber may produce gain in the one or more communication wavelengths of laser light.

The first set of the one or more wavelengths of pump laser light may include one or more of the following wavelengths: 970 nm±1.0 nm, 972 nm±1.0 nm, 974 nm±1.0 nm, 976 nm±1.0 nm and 978 nm±1.0 nm and the second set of one or more wavelengths of pump laser light may include one or more of the following wavelengths: 970 nm±1.0 nm, 972 nm±1.0 nm, 974 nm±1.0 nm, 976 nm±1.0 nm and 978 nm±1.0 nm

The first set of the one or more wavelengths of pump laser light may include wavelengths of 974 nm±1.0 nm and 974 nm±1.0 nm. The second set of the one or more wavelengths of pump laser light may include wavelengths of 972 nm±1.0 nm and 978 nm±1.0 nm or 976 nm±1.0 nm and 978 nm±1.0 nm.

The first and second sets of wavelengths may be injected into the optical fiber via one or more multiplexers or combiners.

### BRIEF DESCRIPTION OF THE DRAWINGS

FIG. 1A is schematic of an example of a wavelength division multiplexing (WDM) system in accordance with the principles of the present disclosure;

FIGS. 1B-1C are schematics of different configurations of optical amplifiers, in accordance with the principles of the present disclosure, that can be used with the example WDM disclosed in FIG. 1A;

FIGS. 2A-2D are schematics of different configurations of pump lasers, in accordance with the principles of the present disclosure, that can be used with each example amplifier shown in FIGS. 1B-1C; and

FIG. 3 is flow diagram of a method in accordance with the principles of the present disclosure.

### DETAILED DESCRIPTION

As used herein, spatial, or directional terms, such as “left”, “right”, “inner”, “outer”, “above”, “below”, and the like, relate to the disclosure as it is shown in the drawing figures. However, it is to be understood that the disclosure can assume various alternative orientations and, accordingly, such terms are not to be considered as limiting. Further, as used herein, all numbers expressing dimensions, physical characteristics, processing parameters, quantities of ingredients, reaction conditions, and the like, used in the specification and claims are to be understood as being modified in all instances by the term “approximately” or “about”. Accordingly, unless indicated to the contrary, the numerical values set forth in the following specification and claims may vary depending upon the desired properties sought to be obtained by the present disclosure.

At the very least, and not as an attempt to limit the application of the doctrine of equivalents to the scope of the claims, each numerical value should at least be construed in light of the number of reported significant digits and by applying ordinary rounding techniques. Moreover, all ranges disclosed herein are to be understood to encompass the beginning and ending range values and any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 3.3, 4.7 to 7.5, 5.5 to 10, and the like. “A” or “an” refers to one or more.

As used herein, “coupled”, “coupling”, and similar terms refer to two or more elements that are joined, linked, fastened, connected, put in communication, or otherwise associated (e.g., mechanically, electrically, fluidly, optically, electromagnetically) with one another. In various examples, the elements may be associated directly or indirectly. As an example, clement A may be directly associated with element B. As another example, element A may be indirectly associated with element B, for example, via another element C. It will be understood that not all associations among the various disclosed elements are necessarily represented. Accordingly, couplings other than those depicted in the figures may also exist.

As used herein, the phrase “at least one of”, when used with a list of items, means different combinations of one or more of the listed items may be used and only one of each item in the list may be needed. For example, “at least one of item A, item B, and item C” may include, without limitation, item A or item A and item B. This example also may include item A, item B, and item C, or item B and item C. In other examples, “at least one of” may be, for example, without limitation, two of item A, one of item B, and ten of item C; four of item B and seven of item C; and other suitable combinations.

The following examples will be described in connection with providing or creating inversion in an erbium doped fiber amplifier (EDFA). However, this is not to be construed in a limiting sense since it is envisioned that in each example, the EDFA may be replaced with a bismuth, praseodymium, or neodymium doped fiber amplifier.

Various non-limiting examples will now be described with reference to the accompanying figures where like reference numbers and their primes, e.g., 28 and 28′, correspond to like or functionally equivalent elements.

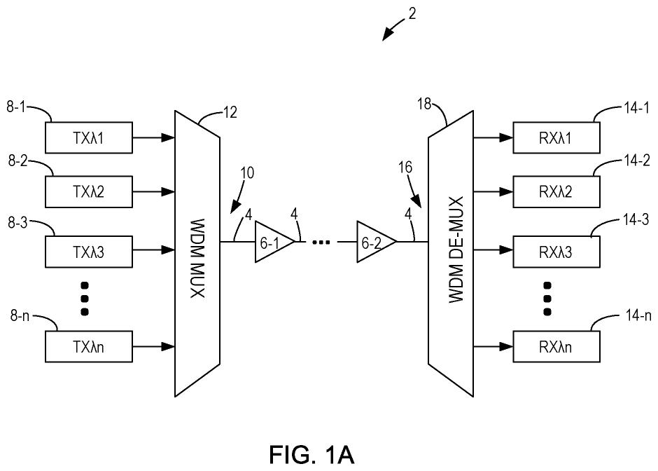

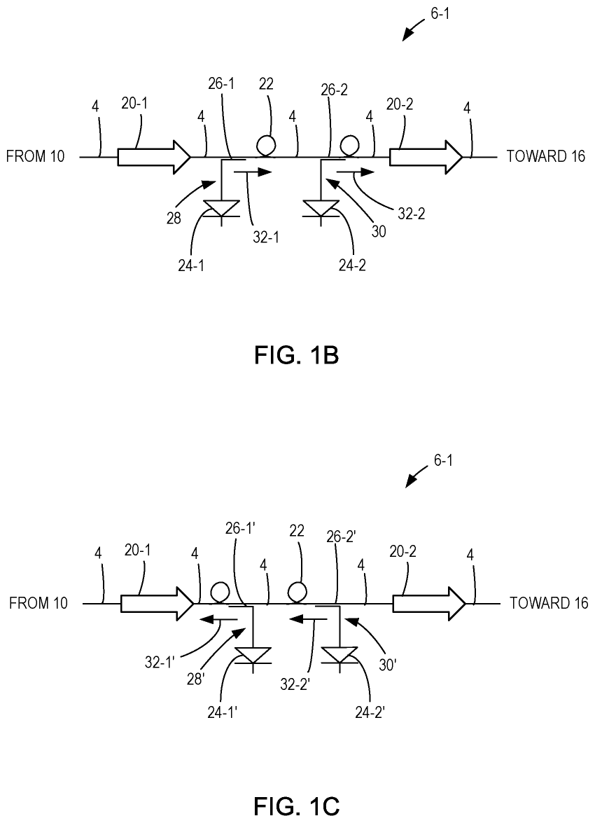

With reference to FIG. 1A, an example wavelength division multiplexing (WDM) system 2 in accordance with the principles of the present disclosure may comprise a transmission optical fiber 4, one or more optical amplifiers 6, e.g., optical amplifiers 6-1 and/or 6-2, for optically amplifying an optical signal or laser light propagating in the transmission optical fiber 4, one or more laser transmitters 8-1 . . . 8-n coupled to an input end 10 of the transmission optical fiber 4 via a WDM multiplexer 12, and one or more laser receivers 14-1 . . . 14-n coupled to an output end 16 of the transmission optical fiber 4 via a WDM de-multiplexer 18. In an example, the transmission optical fiber 4 may be realized by a number of serially connected lengths of transmission optical fiber. In an example, the transmission optical fiber 4 or each length thereof may be a Corning® SMF-28® optical fiber manufactured by Corning Incorporated of Corning, New York, USA. Corning® and SMF-28® are registered trademarks of Corning Incorporated of Corning, New York, USA.

The one or more laser transmitters 8-1 . . . 8-n may be configured and/or operative for generating one or more communication wavelengths λ1 . . . λn of laser light that are multiplexed together by the WDM multiplexer 12 and input into the input end 10 of the transmission optical fiber 4. The one or more multiplexed communication wavelengths λ1 . . . λn of laser light received at the input end 10 of the transmission optical fiber 4 propagate, via the one or more optical amplifiers 6 where said one or more multiplexed communication wavelengths λ1 . . . λn of laser light is/are amplified, to the output end 16 of the transmission optical fiber 4 where the multiplexed communication wavelengths λ1 . . . λn of laser light are de-multiplexed by the de-multiplexer 18 and provided to the one or more laser receivers 14-1 . . . 14-n.

In a non-limiting example where the variable “n”=3, the laser transmitter 8-1 and the laser receiver 12-1 may be configured to respectively transmit and receive communication wavelength λ1 in a first band of laser light in one of the C-band, L-band, S-band, O-band, E-band or U-band; the laser transmitter 8-2 and the laser receiver 12-2 may be configured to respectively transmit and receive communication wavelength λ2 in a second band of laser light in different one of the C-band, L-band, S-band, O-band, E-band or U-band than the first band of laser light; and the laser transmitter 8-3 and the laser receiver 12—which may be configured to respectively transmit and receive communication wavelength λ3 in a third band of laser light that is different than the first and second bands of laser light. This example, however, is not to be construed in a limiting sense since the variable “n” may be equal to one or more.

In practice, each band of laser light may comprise a number of channels or wavelengths of laser light, e.g., 96 or more channels or wavelengths, and some channels or wavelengths may be present in more than one band. For the purpose of simplicity and not of limitation, this disclosure will be described in connection with communication channels or wavelengths λ1 . . . λn of laser light, e.g., communication wavelengths λ1, λ2 and λ3 of laser light.

In an example, each of the one or more communication wavelengths λ1 . . . λn of laser light may include one or more wavelengths of laser light in one or more of a C-band, an L-band, an S-band, an O-band, an E-band and a U-band. In an example, the C-band may have a wavelength range between about 1525 nm and 1565 nm; the L-band may have a wavelength range between about 1565 nm and 1625 nm; the S-band may have a wavelength range between about 1460 nm and 1530 nm; the O-band may have a wavelength range between about 1260 nm and 1360 nm; the E-band may have a wavelength range between about 1360 nm to 1460 nm; and the U-band may have a wavelength range between about 1675 nm and 1700 nm.

### EXAMPLE 1

With reference to FIG. 1B and with continuing reference to FIG. 1A, in one non-limiting example or aspect, the WDM system 2 may include one or more instances of optical amplifier 6-1 along the length of the transmission optical fiber 4, i.e., one or more instances of optical amplifier 6-2 shown in FIG. 1A may be omitted. For the purpose of simplicity hereinafter, while only the one instance of optical amplifier 6-1 shown in FIG. 1A will be described, it is to be appreciated that this description of this optical amplifier 6-1 may be applicable to any other instance of optical amplifier 6-1 that may be dispersed along the length of the transmission optical fiber 4.

Optical amplifier 6-1 may include an optional input optical isolator 20-1 having an input coupled (directly or indirectly) to the input end 10 of the transmission optical fiber 4 and an optional output optical isolator 20-2 having an output coupled (directly or indirectly) to the output end 16 of the transmission optical fiber 4. The optical amplifier 6-1 may also include a length of erbium doped fiber (EDF) 22 having an input end connected to an output of the input optical isolator 20-1 and an output end connected to an input of the output optical isolator 20-2. The examples described in this disclosure will refer to EDF 22. However, this is not to be construed in a limiting sense since it is envisioned that the EDF 22 may be replaced with an optical fiber doped with bismuth, praseodymium, thulium, ytterbium, holmium, dysprosium, neodymium, or a combination of erbium/ytterbium and used with injected pump laser light of wavelengths other than the wavelengths described in this disclosure.

The optical amplifier 6-1 may include a first pump laser 24-1 that may coupled, e.g., via a combiner or multiplexer 26-1, to the EDF 22 closer to the input optical isolator 20-1. The optical amplifier 6-1 may also include a second pump laser 24-2 that may be coupled, e.g., via a combiner or multiplexer 26-2, to the EDF 22 closer to the output optical isolator 20-2. Depending on the number of wavelengths of pump laser light to be injected into the EDF 22, the optical amplifier 6-1 may include a one, two or more pump lasers 24 as may be deemed suitable and/or desirable for an application.

In an example, the first and second pump lasers 24-1 and 24-2 of optical amplifier 6-1 may be operative or configured for injecting into the EDF 22, via the combiners 26-1 and 26-2, a first set of one or more wavelengths of pump laser light 28 and a second set of one or more wavelengths of pump laser light 30. In an example, the wavelengths of the first and second sets of pump laser light 28 and 30 injected into the EDF 22 of optical amplifier 6-1 may be different from each other and the wavelengths of the first and second sets of pump laser light 28 and 30 injected into the EDF 22 of optical amplifier 6-1 may also be different from the one or more communication wavelengths λ1 . . . λn of laser light propagating through the optical amplifier 6-1 on the EDF 22.

In an example, the first set of one or more wavelengths of pump laser light 28 injected into the EDF 22 of optical amplifier 6-1 may include one or more wavelengths in a range of wavelengths between 968 nm and 982 nm. In an example, the first set of one or more wavelengths of pump laser light 28 injected into the EDF 22 of optical amplifier 6-1 may include one or more of the following wavelengths: 970 nm±0.5 nm, 972 nm±0.5 nm, 974 nm±0.5 nm, 976 nm±0.5 nm and 978 nm±0.5 nm. In an example, the second set of one or more wavelengths of pump laser light 30 injected into the EDF 22 of optical amplifier 6-1 may also include one or more wavelengths in a range of wavelengths between 968 nm and 982 nm. In an example, the second set of one or more wavelengths of pump laser light 30 injected into the EDF 22 of optical amplifier 6-1 may include one or more of the following wavelengths: 970 nm±0.5 nm, 972 nm±0.5 nm, 974 nm±0.5 nm, 976 nm±0.5 nm and 978 nm±0.5 nm. However, as noted above, the wavelengths of the first and second sets of pump laser light 28 and 30 injected into the EDF 22 of optical amplifier 6-1 may be different from each other. In an example, the first set of one or more wavelengths of pump laser light 28 may include a single wavelength and the second set of one or more wavelengths of pump laser light 30 may include a different single wavelength. However, this is not to be construed in a limiting sense. Moreover, while the wavelengths of each the first and second sets of pump laser light 28 and 30 may be described as varying by ±0.5 nm, this is not to be construed as limiting since it is envisioned that throughout this disclosure each of these one or more wavelengths may vary by as much as ±1.0 nm.

In the example amplifier 6-1 shown in FIG. 1B, the first and second sets of one or more wavelengths of pump laser light 28 and 30 may be injected, via the combiners 26-1 and 26-2, into the EDF 22 toward the output end 16 of the transmission optical fiber 4, i.e., co-propagating in the same direction as the propagation direction of the one or more multiplexed communication wavelengths λ1 . . . λn of laser light. This injection direction of one or more wavelengths of pump laser light 28 and 30 toward the output end 16 of the transmission optical fiber 4 is shown in FIG. 1B by arrows 32-1 and 32-2.

### EXAMPLE 2

With reference to FIG. 1C and with continuing reference to FIG. 1A, in another non-limiting example or aspect, the WDM 2 may include one or more instances of optical amplifier 6-2 along the length of the transmission optical fiber 4, i.e., one or more instances of optical amplifier 6-1 shown in FIG. 1A may be omitted. For the purpose of simplicity hereinafter, while only the one instance of optical amplifier 6-2 shown in FIG. 1 will be described, it is to be appreciated that this description of optical amplifier 6-2 may be applicable to any other instance of optical amplifier 6-2 that may be dispersed along the length of the transmission optical fiber 4.

Optical amplifier 6-2 may be similar to optical amplifier 6-1 described above with the following exceptions, namely, the first and second sets of one or more wavelengths of pump laser light 28′ and 30′ may be injected by first and second pump lasers 24-1′ and 24-2′ of optical amplifier 6-2, via the combiners 26-1′ and 26-2′, into the EDF 22 of optical amplifier 6-2 toward the input end 10 of the transmission optical fiber 4, i.e., counter-propagating in an direction opposite to the propagation direction of the one or more multiplexed communication wavelengths λ1 . . . λn of laser light. This injection direction of one or more wavelengths of pump laser light 28′ and 30′ toward the input end 16 of the transmission optical fiber 4 is shown in FIG. 1C by arrows 32-1′ and 32-2′.

In an example, the first and second pump lasers 24-1′ and 24-2′ of optical amplifier 6-2 may be operative or configured for injecting into the EDF 22, via the combiners 26-1′ and 26-2′, a first set of one or more wavelengths of pump laser light 28′ and a second set of one or more wavelengths of pump laser light 30′. In an example, the wavelengths of the first and second sets of pump laser light 28′ and 30′ injected into the EDF 22 may be different from each other and the wavelengths of the first and second sets of pump laser light 28′ and 30′ injected into the EDF 22 may also be different from the one or more communication wavelengths λ1 . . . λn of laser light propagating through the optical amplifier 6-1 on the EDF 22. In an example, the first set of one or more wavelengths of pump laser light 28′ may include a single wavelength and the second set of one or more wavelengths of pump laser light 30′ may include a different single wavelength. However, this is not to be construed in a limiting sense.

In an example, the first set of one or more wavelengths of pump laser light 28′ injected into the EDF 22 of optical amplifier 6-2 may include one or more wavelengths in a range of wavelengths between 968 nm and 982 nm. In an example, the first set of one or more wavelengths of pump laser light 28′ injected into the EDF 22 of optical amplifier 6-2 may include one or more of the following wavelengths: 970 nm±0.5 nm, 972 nm±0.5 nm, 974 nm±0.5 nm, 976 nm±0.5 nm and 978 nm±0.5 nm. In an example, the second set of one or more wavelengths of pump laser light 30′ injected into the EDF 22 of optical amplifier 6-2 may include one or more wavelengths in a range of wavelengths between 968 nm and 982 nm. In an example, the second set of one or more wavelengths of pump laser light 30′ injected into the EDF 22 of optical amplifier 6-2 may include one or more of the following wavelengths: 970 nm±0.5 nm, 972 nm±0.5 nm, 974 nm±0.5 nm, 976 nm±0.5 nm and 978 nm±0.5 nm. However, as discussed above, the wavelengths of the first and second sets of pump laser light 28′ and 30′ injected into the EDF 22 of optical amplifier 6-2 may be different from each other. Moreover, while the wavelengths of each the first and second sets of pump laser light 28′ and 30′ may be described as varying by ±0.5 nm, this is not to be construed as limiting since it is envisioned that throughout this disclosure each of these one or more wavelengths may vary by as much as ±1.0 nm.

With reference to the example WDM 2 system shown in FIG. 1A and the optical amplifiers 6-1 and 6-2 shown in FIGS. 1B and 1C, in one specific non-limiting example, one or more of the C-band, the L-band, the S-band, the O-band, the E-band and/or the U-band of communication wavelengths or one or more communication wavelengths λ1 . . . λn of laser light may be input by the one or more one or more laser transmitters 8-1 . . . 8-n into the input end 10 of the transmission optical fiber 4 for propagation to the output end 16 of the transmission optical fiber 4 for receipt by the one or more one or more laser receivers 12-1 . . . 12-n. Concurrently, the first set of one or more wavelengths of pump laser light and the second set of one or more wavelengths of pump laser light may be injected into the EDF 22: (1) toward the output end 16 of the transmission optical fiber 4 (FIG. 1B), whereupon the injected pump laser light 28 and 30 co-propagates with the one or more bands of communication wavelengths λ1 . . . λn of laser light; or (2) toward the input end 10 of the transmission optical fiber 4 (FIG. 1C), whereupon the injected pump laser light 28′ and 30′ counter-propagates in an direction opposite to the propagation direction of the one or more bands of communication wavelengths λ1 . . . λn of laser light.

In one specific non-limiting example, the first set of one or more wavelengths of pump laser light 28 or 28′ may include a single wavelength of 974 nm±0.5 nm and the second set of one or more wavelengths of pump laser light 30 or 30′ may include a single wavelength of 976 nm±0.5 nm. However, this is not to be construed in a limiting sense since it is envisioned that each of the first and second sets of one or more wavelengths of pump laser light (28 and 30 or 28′ and 30′) injected into the EDF 22 may include any one or more of the following wavelengths: 970 nm±0.5 nm, 972 nm±0.5 nm, 974 nm±0.5 nm, 976 nm±0.5 nm and 978 nm±0.5 nm, provided that the first and second sets of one or more wavelengths of pump laser light 28 and 30 or 28′ and 30′ have no wavelengths in common, i.e., the first and second sets of one or more wavelengths of pump laser light 28 and 30 or 28′ and 30′ are mutually exclusive or disjoint.

It has been observed that when two or more different wavelengths of pump laser light at the above-noted wavelengths are injected in a co-propagating or counter-propagating direction as the above-noted bands of communication wavelengths λ1 . . . λn of laser light, inversion is produced or created in the EDF 22 which aids in achieving higher gain and/or output power in the bands of communication wavelengths λ1 . . . λn of laser light propagating in the transmission optical fiber 4.

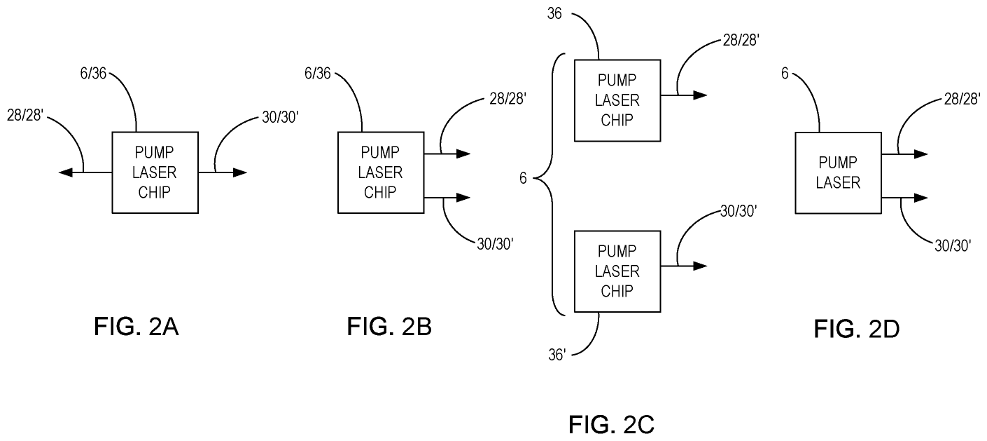

With reference to FIGS. 2A-2D, in an example, the first and second sets of the one or more wavelengths of pump laser light 28 and 30 and/or 28′ and 30′ may be produced from two sides of a single pump laser chip 36 comprising pump laser 6 (FIG. 2A), or from two outputs on one side of a single laser chip 36 comprising pump laser 6 (FIG. 2B), or from two laser chips 36 and 36′ comprising pump laser 6 (FIG. 1D), from one side of a single pump laser 6 (FIG. 1E).

### EXAMPLE 3

With continuing reference to FIGS. 1A-1C, in another example, the WDM 2 may include one or more pairs of optical amplifiers 6-1 and 6-2. For the purpose of this disclosure, only one pair of optical amplifiers 6-1 and 6-2 (shown in FIG. 1A) will be described. However, this is not to be construed in a limiting sense. In this example, a first set of one or more wavelengths of pump laser light (28 and 30) and a second set of one or more wavelengths of pump laser light (28′ and 30′) may be simultaneously injected into the respective EDFs 22 of the optical amplifiers 6-1 and 6-2, via the pump lasers 24-1 and 24-2 of optical amplifier 6-1 (for pump laser light 28 and 30) and the pump lasers 24-1′ and 24-2′ of optical amplifier 6-2 (for pump laser light 28′ and 30′), toward the respective output end 16 and input end 10 of the transmission optical fiber 4. In this example, the first set of one or more wavelengths of pump laser light 28 and 30 co-propagate in the same direction as the propagation direction of the one or more multiplexed communication wavelengths λ1 . . . λn of laser light while the second set of one or more wavelengths of pump laser light 28′ and 30′ counter-propagate in a direction opposite to the propagation direction of the one or more multiplexed communication wavelengths λ1 . . . λn of laser light.

In this example (like the above example), the first set of one or more wavelengths of pump laser light 28 and 30 injected into the EDF 22 of optical amplifier 6-1 may include one or more wavelengths in a range of wavelengths between 968 nm and 982 nm. In an example, the first set of one or more wavelengths of pump laser light 28 and 30 injected into the EDF 22 of optical amplifier 6-1 may include one or more of the following wavelengths: 970 nm±0.5 nm, 972 nm±0.5 nm, 974 nm±0.5 nm, 976 nm±0.5 nm and 978 nm±0.5 nm. In an example, the second set of one or more wavelengths of pump laser light 28′ and 30′ injected into the EDF 22 of optical amplifier 6-2 may include one or more wavelengths in a range of wavelengths between 968 nm and 982 nm. In an example, the second set of one or more wavelengths of pump laser light 28′ and 30′ injected into the EDF 22 of optical amplifier 6-2 may include one or more of the following wavelengths: 970 nm±0.5 nm, 972 nm±0.5 nm, 974 nm±0.5 nm, 976 nm±0.5 nm and 978 nm±0.5 nm. However, as discussed above, the wavelengths of the first set of one or more wavelengths of pump laser light 28 and 30 and the second set of one or more wavelengths of pump laser light 28′ and 30′ injected into the EDFs 22 of optical amplifiers 6-1 and 6-2 may be different from each other. Moreover, while the wavelengths each of the first set of one or more wavelengths of pump laser light (28 and 30) and the second set of one or more wavelengths of pump laser light (28′ and 30′) may be described as varying by ±0.5 nm, this is not to be construed as limiting since it is envisioned that throughout this disclosure each of these one or more these wavelengths may vary by as much as ±1.0 nm.

In one non-limiting example, the first set of one or more wavelengths of pump laser light 28 and/or 30 may include a single wavelength of 974 nm±0.5 nm injected into the EDF 22 by at least one of the pump lasers 24-1 and 24-2 and the second set of one or more wavelengths of pump laser light 28′ and/or 30′ may include a single wavelength of 976 nm±0.5 nm injected into the EDF 22 by at least one of the pump lasers 24-1′ and 24-2′.

In another non-limiting example, the first set of one or more wavelengths of pump laser light 24 may include, for example, wavelengths of 974 nm±0.5 nm and 976 nm±0.5 nm injected by respective pump lasers 24-1 and 24-2 while the second set of one or more wavelengths of pump laser light 24 may include, for example, wavelengths of 972 nm±0.5 nm (or 976 nm±0.5 nm) and 978 nm±0.5 nm injected by respective pump lasers 24-1′ and 24-2′.

It has been observed that when two or more different wavelengths of pump laser light at the above-noted wavelengths are simultaneously injected in both the co-propagating direction and the counter-propagating direction as the above-noted bands of communication wavelengths λ1 . . . λn of laser light, inversion is produced or created in the EDFs 22 of optical amplifiers 6-1 and 6-2 which aids in achieving higher gain and/or output power in the bands of communication wavelengths λ1 . . . λn of laser light propagating in the transmission optical fiber 4.

In this disclosure, the number of pump lasers of each optical amplifier may be selected based on the number of wavelengths of pump laser light to be injected by the optical amplifier. For example, if an optical amplifier is to be used to inject one wavelength of pump laser light, the optical amplifier may include only one pump laser. In another example, if an optical amplifier is to be used to inject a plurality of wavelengths of pump laser light, the optical amplifier may include a like plurality of pump lasers. Accordingly, the illustration of optical amplifier 6-1 including pump lasers 24-1 and 24-2 and optical amplifier 6-2 including pump lasers 24-1′ and 24-2′ is not to be construed in a limiting sense.

While the foregoing Examples 1-3 have been described in connection with pump laser light in a range of wavelengths between 968 nm and 982 nm, this is not to be construed in a limiting sense since it is envisioned that each range of wavelengths between 968 nm and 982 nm may be replaced with a range of wavelengths between 1470 nm and 1490 nm. For example, the first set of one or more wavelengths of pump laser light 28 and 30 injected into the EDF 22 of optical amplifier 6-1 may include one or more of the following wavelengths: 1472 nm±0.5 nm, 1474 nm±0.5 nm, 1476 nm±0.5 nm, 1478 nm±0.5 nm, 1480 nm±0.5 nm, 1482 nm±0.5 nm, 1484 nm±0.5 nm, 1486 nm±0.5 nm and 1488 nm±0.5 nm. In this example, the second set of one or more wavelengths of pump laser light 28′ and 30′ injected into the EDF 22 of optical amplifier 6-2 may include one or more of the following wavelengths: 1472 nm±0.5 nm, 1474 nm±0.5 nm, 1476 nm±0.5 nm, 1478 nm±0.5 nm, 1480 nm±0.5 nm, 1482 nm±0.5 nm, 1484 nm±0.5 nm, 1486 nm±0.5 nm and 1488 nm±0.5 nm. While the wavelengths each of the first set of one or more wavelengths of pump laser light (28 and 30) in range of wavelengths between 1470 nm and 1490 nm and the second set of one or more wavelengths of pump laser light (28′ and 30′) in range of wavelengths between 1470 nm and 1490 nm may be described as varying by ±0.5 nm, this is not to be construed as limiting since it is that each of these one or more these wavelengths may vary by as much as ±1.0 nm.

It is to be appreciated that in the examples described in this disclosure, the wavelengths of the first and second sets of one or more wavelengths of injected pump laser light in the range of wavelengths between 968 nm and 982 nm or between 1470 nm and 1490 nm may be selected as may be suitable and/or desirable to produce or create inversion in the EDF 22 which aids in achieving higher gain and/or output power in the bands of communication wavelengths λ1 . . . λn of laser light propagating in the transmission optical fiber 4. For example, the wavelengths of each he first and second sets of one or more wavelengths of injected pump laser light may include one or more even wavelengths (e.g., 970 nm or 1472 nm), or one or more odd wavelengths (e.g., 971 nm or 1473 nm), or one or more fractional wavelengths (e.g., 971.5 nm or 1472.3 nm), or some combination thereof. Accordingly, the specific examples of the wavelengths of each of the first and second sets of one or more wavelengths of injected pump laser light described in the above the examples is/are not to be construed in a limiting sense.

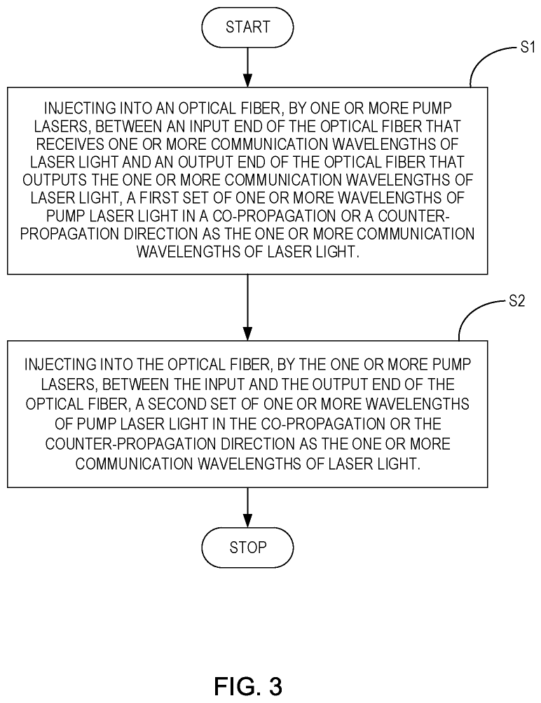

With reference to FIG. 3 and with continuing reference to all previous figures, a method of amplification in an optical fiber having an input end for receiving, from one or more laser transmitters, one or more communication wavelengths of laser light and an output end for outputting, to one or more laser receivers, the one or more communication wavelengths of laser light may include step S1 wherein a first set of one or more wavelengths of pump laser light are injected into the optical fiber, by one or more pump lasers, between the input and the output end of the optical fiber in a co-propagation or a counter-propagation direction as the one or more communication wavelengths of laser light. In step S2, a second set of one or more wavelengths of pump laser light are injected into the optical fiber, by the one or more pump lasers, between the input and the output end of the optical fiber in the co-propagation or the counter-propagation direction as the one or more communication wavelengths of laser light.

In the method, the wavelengths of the first and second sets of pump laser light injected into the optical fiber may be different from each other in a range between 968 nm and 982 nm or between 1470 nm and 1490 nm and create an inversion in the optical fiber and the wavelengths of the first and second sets of pump laser light injected into the optical fiber may be different from the one or more communication wavelengths of laser light.

The first set of the one or more wavelengths of pump laser light and second set of the one or more wavelengths of pump laser light may be injected into the optical fiber in the same direction toward the output end of the optical fiber, or may be injected into the optical fiber in the same direction toward the input end of the optical fiber, or may be injected into the optical fiber in different directions.

Other non-limiting examples or aspects of this disclosure are set forth in the following illustrative and exemplary numbered clauses:

Clause 1: In a method of amplification in an optical fiber having an input end for receiving from one or more laser transmitters, one or more communication wavelengths of laser light and an output end for outputting, to one or more laser receivers, the one or more communication wavelengths of laser light, the method comprises: (a) injecting into the optical fiber, by one or more pump lasers, between the input and the output end of the optical fiber, a first set of one or more wavelengths of pump laser light; and (b) injecting into the optical fiber, by the one or more pump lasers, between the input and the output end of the optical fiber, a second set of one or more wavelengths of pump laser light. Wherein the wavelengths of the first and second sets of pump laser light injected into the optical fiber are different from each other in a range between 968 nm and 982 nm or between 1470 nm and 1490 nm and produce or create an inversion in the optical fiber, and the wavelengths of the first and second sets of pump laser light injected into the optical fiber are different from the one or more communication wavelengths of laser light.

Clause 2: The method of clause 1, wherein the first set of the one or more wavelengths of pump laser light and second set of the one or more wavelengths of pump laser light may be injected into the optical fiber in the same direction toward the output end of the optical fiber.

Clause 3: The method of clause 1 or 2, wherein the first set of the one or more wavelengths of pump laser light and second set of the one or more wavelengths of pump laser light may be injected into the optical fiber in the same direction toward the input end of the optical fiber.

Clause 4: The method of any one of clauses 1-3, wherein the first set of the one or more wavelengths of pump laser light and second set of the one or more wavelengths of pump laser light may be injected into the optical fiber in different directions.

Clause 5: The method of any one of clauses 1-4, wherein the first set of one or more wavelengths of pump laser light may include one or more wavelengths in the range between 968 nm and 982 nm and the second set of one or more wavelengths of pump laser light may include one or more wavelengths in the range between 968 nm and 982 nm.

Clause 6: The method of any one of clauses 1-5, wherein the one or more communication wavelengths of laser light may comprise one or more wavelengths in one or more of a C-band, an L-band, an S-band, an O-band, an E-band and a U-band.

Clause 7: The method of any one of clauses 1-6, wherein injecting the first and second sets of one or more wavelengths of the pump laser light into the optical fiber may produce gain in the one or more communication wavelengths of laser light.

Clause 8: The method of any one of clauses 1-7, wherein the first and second sets of the one or more wavelengths of the pump laser light may be produced from two sides of a single laser chip.

Clause 9: The method of any one of clauses 1-8, wherein the first and second sets of the one or more wavelengths of the pump laser light may be produced from two outputs on one side of a single laser chip.

Clause 10: The method of any one of clauses 1-9, wherein the first and second sets of the one or more wavelengths of the pump laser light may be produced from two laser chips.

Clause 11: The method of any one of clauses 1-10, wherein the first and second sets of the one or more wavelengths of the pump laser light may be produced from one side of a single laser.

Clause 12: The method of any one of clauses 1-11, wherein: the first set of the one or more wavelengths of pump laser light may include a wavelength of 974 nm±1.0 nm; and the second set of the one or more wavelengths of pump laser light may include a wavelength of 976 nm±1.0 nm.

Clause 13: The method of any one of clauses 1-12, wherein: the first set of the one or more wavelengths of pump laser light may include wavelengths of 974 nm±1.0 nm and 974 nm±1.0 nm; and the second set of the one or more wavelengths of pump laser light may include wavelengths 972 nm±1.0 nm and 978 nm±1.0 nm or 976 nm±1.0 nm and 978 nm±1.0 nm.

Clause 14: The method of any one of clauses 1-13, wherein the optical fiber may doped with erbium.

Clause 15: The method of any one of clauses 1-14, wherein the first and second sets of wavelengths may be injected into the optical fiber via one or more combiners or multiplexers.

Clause 16: The method of any one of clauses 1-14, wherein the first set of one or more wavelengths of pump laser light may include one or more wavelengths in the range between 1470 nm and 1490 nm and the second set of one or more wavelengths of pump laser light may include one or more wavelengths in the range between 1470 nm and 1490 nm.

Although this disclosure has been described in detail for the purpose of illustration based on what is currently considered to be the most practical and preferred embodiments, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

1. A method of amplification in an optical fiber having an input end for receiving, from one or more laser transmitters, one or more communication wavelengths of laser light and an output end for outputting, to one or more laser receivers, the one or more communication wavelengths of laser light, the method comprising:
(a) injecting into the optical fiber, by one or more pump lasers, between the input and the output end of the optical fiber, a first set of one or more wavelengths of pump laser light; and
(b) injecting into the optical fiber, by the one or more pump lasers, between the input and the output end of the optical fiber, a second set of one or more wavelengths of pump laser light, wherein:
the wavelengths of the first and second sets of pump laser light injected into the optical fiber are different from each other in a range between 968 nm and 982 nm or between 1470 nm and 1490 nm and create an inversion in the optical fiber; and
the wavelengths of the first and second sets of pump laser light injected into the optical fiber are different from the one or more communication wavelengths of laser light.

2. The method of claim 1, wherein the first set of the one or more wavelengths of pump laser light and second set of the one or more wavelengths of pump laser light are injected into the optical fiber in the same direction toward the output end of the optical fiber.

3. The method of claim 1, wherein the first set of the one or more wavelengths of pump laser light and second set of the one or more wavelengths of pump laser light are injected into the optical fiber in the same direction toward the input end of the optical fiber.

4. The method of claim 1, wherein the first set of the one or more wavelengths of pump laser light and second set of the one or more wavelengths of pump laser light are injected into the optical fiber in different directions.

5. The method of claim 1, wherein:
the first set of one or more wavelengths of pump laser light includes one or more wavelengths in the range between 968 nm and 982 nm; and
the second set of one or more wavelengths of pump laser light includes one or more wavelengths in the range between 968 nm and 982 nm.

6. The method of claim 1, wherein the one or more communication wavelengths of laser light comprise one or more wavelengths in one or more of a C-band, an L-band, an S-band, an O-band, an E-band and a U-band.

7. The method of claim 1, wherein injecting the first and second sets of one or more wavelengths of the pump laser light into the optical fiber produces gain in the one or more communication wavelengths of laser light.

8. The method of claim 1, wherein the first and second sets of the one or more wavelengths of the pump laser light are produced from two sides of a single laser chip.

9. The method of claim 1, wherein the first and second sets of the one or more wavelengths of the pump laser light are produced from two outputs on one side of a single laser chip.

10. The method of claim 1, wherein the first and second sets of the one or more wavelengths of the pump laser light are produced from two laser chips.

11. The method of claim 1, wherein the first and second sets of the one or more wavelengths of the pump laser light are produced from one side of a single laser.

12. The method of claim 1, wherein:
the first set of the one or more wavelengths of pump laser light includes a wavelength of 974 nm±1.0 nm; and
the second set of the one or more wavelengths of pump laser light includes a wavelength of 976 nm±1.0 nm.

13. The method of claim 1, wherein:
the first set of the one or more wavelengths of pump laser light includes wavelengths of 974 nm±1.0 nm and 976 nm±1.0 nm; and
the second set of the one or more wavelengths of pump laser light includes wavelengths of 972 nm±1.0 nm and 978 nm±1.0 nm or 976 nm±1.0 nm and 978 nm±1.0 nm.

14. The method of claim 1, wherein the optical fiber is doped with erbium.

15. The method of claim 1, wherein the first and second sets of wavelengths are injected into the optical fiber via one or more combiners or multiplexers.

16. The method of claim 1, wherein:
the first set of one or more wavelengths of pump laser light includes one or more wavelengths in the range between 1470 nm and 1490 nm; and
the second set of one or more wavelengths of pump laser light includes one or more wavelengths in the range between 1470 nm and 1490 nm.
